(19) United States
(12) Patent Application Publication
(10) Pub. No.: US 2025/0337988 A1
(43) Pub. Date: Oct. 30, 2025

(54) INFORMATION DISPLAY METHOD AND APPARATUS

(71) Applicant: Beijing Zitiao Network Technology Co., Ltd., Beijing (CN)

(72) Inventors: Haichen YU, Beijing (CN); Hanfei WU, Beijing (CN); Jiaxin WANG, Beijing (CN)

(21) Appl. No.: 18/871,450

(22) PCT Filed: Sep. 27, 2023
(86) PCT No.: PCT/CN2023/121995

§ 371 Date: Dec. 3, 2024

(30) Foreign Application Priority Data
Sep. 27, 2022 (CN) 202211185838.3

(51) Int. Cl. H04N 21/472; H04N 21/482

(52) U.S. Cl. CPC H04N 21/472; H04N 21/482

(57) ABSTRACT

The present disclosure discloses an information display method, an information display apparatus, a device, and a non-transitory computer readable storage medium. The method includes: displaying a first interface on a video playback page in response to a trigger operation on an interactive identifier on the video playback page, a first region of the first interface displaying a first content; and displaying a second content in the first region of the first interface and displaying the first content in a second region, in response to a slide operation triggered on the first interface.

The present disclosure claims the priority of the Chinese Patent Application No. 202211185838.3, entitled “Information Display Method and Apparatus” and filed to China National Intellectual Property Administration on Sep. 27, 2022, the entire contents of the Chinese Patent application are incorporated herein by reference in its entirety.

### TECHNICAL FIELD

The present disclosure relates to a field of computer technologies, and more particularly, to an information display method and apparatus.

### BACKGROUND

At present, in order to enrich interactive experience of a user when watching a video, an interactive identifier may be displayed on a video playback page, and the user may trigger an interactive operation through the interactive identifier. In one example, after the user performs a trigger operation on the interactive identifier, a client may display a corresponding interface and show a corresponding content on the interface.

After the client displays the interface, the user may trigger a corresponding operation on the interface. At present, the interactive experience brought by the interactive operation triggered by the user on the interface needs to be improved, and efficiency of information acquisition is relatively low. Therefore, there is an urgent need for a solution that can solve the above-described problems.

### SUMMARY

In order to solve or at least partially solve the above technical problems, an embodiment of the present application provides an information display method and apparatus.

In a first aspect, an embodiment of the present disclosure provides an information display method, and the method comprises:
displaying a first interface on a video playback page in response to a trigger operation on an interactive identifier on the video playback page, a top region of the first interface displaying a first content; and
displaying a second content in the top region of the first interface and displaying the first content in other region except the top region, in response to a slide operation triggered on the first interface.

Optionally, the displaying the first content in other region except the top region comprises: displaying the first content in an adjacent region of the top region.

Optionally, the method further comprises:
displaying the first interface in full screen in response to ending of the slide operation.

Optionally, the first content comprises a content associated with a first resource, and the second content comprises an image associated with the first resource.

Optionally, the first content comprises a content associated with a provider of the first resource, and the second content comprises an image associated with the first resource.

Optionally, the method further comprises:
displaying a resource transfer interface corresponding to the first resource in response to a first trigger operation on the image associated with the first resource; and acquiring the first resource in response to a resource transfer completion operation on the resource transfer interface.

Optionally, the method further comprises:
displaying at least one interactive control in response to a second trigger operation on the image associated with the first resource; and executing an interactive function corresponding to the interactive control in response to a trigger operation on a target interactive control in the at least one interactive control.

Optionally, the video playback page is a video playback page associated with the first resource, the interactive identifier is an interactive identifier associated with the first resource, and the first interface is a detail page of the first resource.

In a second aspect, an embodiment of the present disclosure provides an information display apparatus, and the apparatus comprises:
a first display unit, configured to display a first interface on a video playback page in response to a trigger operation on an interactive identifier on the video playback page, a top region of the first interface displaying a first content; and
a second display unit, configured to display a second content in the top region of the first interface and display the first content in other region except the top region, in response to a slide operation triggered on the first interface.

Optionally, the displaying the first content in other region except the top region comprises:
displaying the first content in an adjacent region of the top region.

Optionally, the apparatus further comprises:
a third display unit, configured to display the first interface in full screen in response to ending of the slide operation.

Optionally, the first content comprises a content associated with a first resource, and the second content comprises an image associated with the first resource.

Optionally, the first content comprises a content associated with a provider of the first resource, and the second content comprises an image associated with the first resource.

Optionally, the apparatus further comprises:
a fourth display unit, configured to display a resource transfer interface corresponding to the first resource in response to a first trigger operation on the image associated with the first resource; and
an acquisition unit, configured to acquire the first resource in response to a resource transfer completion operation on the resource transfer interface.

Optionally, the apparatus further comprises:
a fifth display unit, configured to display at least one interactive control in response to a second trigger operation on the image associated with the first resource;
an interaction unit, configured to execute an interactive function corresponding to the interactive control in response to a trigger operation on a target interactive control in the at least one interactive control.

Optionally, the video playback page is a video playback page associated with the first resource, the interactive identifier is an interactive identifier associated with the first resource, and the first interface is a detail page of the first resource.

In a third aspect, an embodiment of the present disclosure provides a device, and the device comprises a processor and a memory, the processor is configured to execute instructions stored in the memory to cause the device to execute the method described in any one embodiment in the first aspect above.

In a fourth aspect, an embodiment of the present disclosure provides a computer readable storage medium, comprising instructions, and the instructions instruct a device to execute the method described in any one embodiment in the first aspect above.

In a fifth aspect, an embodiment of the present disclosure provides a computer program product, and the computer program product, when running on a computer, causes the computer to execute the method described in any one embodiment in the first aspect above.

### BRIEF DESCRIPTION OF DRAWINGS

In order to illustrate the technical solutions of the embodiments of the present disclosure or the prior art more clearly, the accompanying drawings needed to be used in the description of the embodiments or the prior art will be briefly introduced below; it will be apparent that the accompanying drawings in the following description are merely some embodiments of the present disclosure, and that other accompanying drawings can also be obtained according to these drawings by those ordinarily skilled in the art without creative efforts.

FIG. 1 is a schematic flow chart of an information display method provided by an embodiment of the present disclosure;

FIG. 2a is a schematic diagram of a video playback page provided by an embodiment of the present disclosure;

FIG. 2b is a schematic diagram of a video playback page provided by an embodiment of the present disclosure;

FIG. 2c is a schematic diagram of a video playback page provided by an embodiment of the present disclosure;

FIG. 2d is a schematic diagram of a first interface provided by an embodiment of the present disclosure; and

FIG. 3 is a structural schematic diagram of an information display apparatus provided by an embodiment of the present disclosure.

### DETAILED DESCRIPTION

In order to make those skilled in the art better understand the technical solutions of the present disclosure, the technical solutions of the embodiments of the present disclosure will be described in a clearly and fully understandable way in conjunction with the accompanying drawings of the embodiments of the present disclosure. It is obvious that the described embodiments are just a part but not all of the embodiments of the present disclosure. Based on the embodiments described in the present disclosure, those ordinarily skilled in the art may obtain other embodiment(s), without any inventive work, which should be within the scope of protection of the present disclosure.

An inventor of the present disclosure finds through study that a client may display an interactive identifier on a video playback page when displaying the video playback page, and a user may trigger an interactive operation through the interactive identifier. In one example, after the user performs a trigger operation on the interactive identifier, the client may display a corresponding interface, and display a corresponding content on the interface. After the client displays the interface, the user may trigger a corresponding operation on the interface. At present, after the user triggers a slide operation on the interface, the client may display the interface in full screen. Moreover, in the process of the user triggering the slide operation, a new content will be displayed at the bottom of the interface, however displaying the new content at the bottom is not favorable for viewing by the user, which leads to a poor user experience.

In order to solve the above-described problems, the embodiments of the present disclosure provide an information display method and apparatus.

The information display method provided by the embodiment of the present disclosure may be executed by a client. The client may display a video playback page, and the video playback page displays an interactive identifier. The user may perform a trigger operation on the interactive identifier, and accordingly, the client may display a first interface on the video playback page in response to the trigger operation on the interactive identifier; a top region of the first interface displays a first content. Further, the user may trigger a slide operation on the first interface, and accordingly, the client may, in response to the slide operation, display a second content in the top region of the first interface and display the first content in other region of the first interface except the top region. Thus, it can be seen that by using the technical solution of the present disclosure, the user may view the newly added second content in the top region of the first interface after triggering the slide operation on the first interface, so that the user can obtain richer information, which improves the user experience and the information acquisition efficiency.

Hereinafter, various non-limitative implementations of the present disclosure will be described in detail in conjunction with the accompanying drawings.

### Exemplary Method

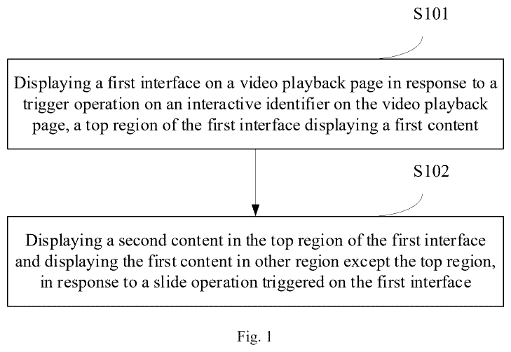

Referring to FIG. 1, which is a schematic flow chart of an information display method provided by an embodiment of the present disclosure. The information display method provided by the embodiment of the present disclosure may be executed by the client.

In the embodiment of the present disclosure, the method, for example, may include step S101 to step 102 as follows.

S101: displaying a first interface on a video playback page in response to a trigger operation on an interactive identifier on the video playback page, a top region of the first interface displaying a first content.

In the embodiment of the present disclosure, the video playback page may be a short video playback page or a live video playback page, which is not specifically limited in the embodiments of the present disclosure.

In one example, the video playback page may be a video playback page associated with a first resource. The embodiments of the present disclosure do not specifically limit the first source; the first resource, for example, may be a goods, or the first resource may also be a store. The goods may be a resource provided by the store. In one example, if the first resource is a goods, then a provider of the first resource may be a store that provides the goods.

In the embodiment of the present disclosure, the interactive identifier is an interactable component. and is used for receiving the trigger operation requesting to enter the first interface. The interactive identifier may include an interactive icon; and the interactive icon may be an icon having a certain shape, for example, a triangular icon or a circular icon. Interactive icons of different shapes may indicate contents with different types; and the contents mentioned here may include the first content and/or a second content as mentioned below.

In one example, when the video playback page is a video playback page associated with the first resource, the interactive identifier may also be an interactive identifier associated with the first resource; and the interactive identifier, for example, may include an interactive icon and a name of the first resource. Through the interactive identifier, a detail page of the first resource may be viewed. That is to say, in such a case, the first interface may be the detail page of the first resource. In the case where the first interface is the detail page of the first resource, interactive icons of different shapes may indicate first resources with different types.

In the embodiment of the present disclosure, the top region of the first interface displays the first content; the first content is not specifically limited in the embodiments of the present disclosure; and the first content includes but is not limited to text, image, and other interactive identifiers that may trigger an interactive operation. The top region of the first interface may be understood as a preset region, which includes a top boundary of the first interface, in the first interface, and the preset region may be, for example, a region, a distance between a lower boundary of which and the top boundary of the first interface is less than a preset distance.

In one example, when the first interface is the detail page of the first resource, the first content may include a content associated with the first resource or a content associated with a provider of the first resource. As an example, when the first resource is a goods, the first content, for example, may include an exchange resource required to be paid for acquiring the goods, or, the first content may also include information of the provider of the goods. As another example, when the first resource is the goods provider, the first content may include a region where the goods provider is located, for example, may also include a name and introduction of the goods provider.

In addition, the first interface may further include other content in addition to the content associated with the first resource. For example. the first content may further include other content, for example, include information of other resource belonging to the same category as the first resource, which is not specifically limited in the embodiments of the present disclosure.

S102: displaying a second content in the top region of the first interface and displaying the first content in other region except the top region, in response to a slide operation triggered on the first interface.

After the first interface is displayed, the user may trigger the slide operation on the first interface, for example, trigger an upward slide operation. Correspondingly, the client may change the content in the top region of the first interface from the first content to the second content in response to the slide operation. Besides, the first content is displayed in other region of the first interface except the top region. The embodiments of the present disclosure do not specifically display the other region, and the other region may be any one region in the first interface except the top region. In one example, considering that the user triggers the slide operation on the first interface, it indicates that the user is more interested in the first content, so that the other region may be an adjacent region of the top region, to facilitate the user to view the first content.

Thus, it can be seen that by using the technical solution of the present disclosure, the user may not only view the first content, but also view the second content not originally included in the first interface, after triggering the slide operation on the first interface, so that the user can obtain richer contents through the first interface, which improves the user experience. Moreover, because the second content is displayed in the top region of the first interface, it is more favorable for the user to view the second content.

In one example, after the user performs the trigger operation on the interactive identifier on the video playback page, the client may display the first interface in a form of window on the video playback page. For such a case, in one example, when the slide operation performed by the user ends, the client may further display the first interface in full screen in response to ending of the slide operation. In this way, the user may view the second content and the first content mentioned above through the first interface displayed in full screen. As compared with the case of viewing the first content and the second content mentioned above through the first interface displayed in the form of window, the case of viewing the second content and the first content mentioned above through the first interface displayed in full screen provides a better user experience.

In one example, when the first interface is displayed in full screen, the top region of the first interface, for example, may further include at least one interactive identifier, to facilitate the user to trigger an interactive operation through the interactive identifier. The interactive identifier is not specifically limited in the embodiments of the present disclosure; and the interactive identifier, for example, may include an interactive identifier for triggering a return operation, an interactive identifier for triggering a close operation, and so on.

With respect to the ending of the slide operation, it should be noted that in one example, the ending of the slide operation may be sliding to the top of the video playback page. In such a case, when the user triggers the slide operation and slides to the top of the video playback page, the user may view the first interface displayed in full screen and view the second content and the first content through the first interface displayed in full screen. In another example, the ending of the slide operation may be stopping the slide operation. In such a case, when the user triggers the slide operation and ends the slide operation, the user may view the first interface displayed in full screen and view the second content and the first content through the first interface displayed in full screen.

Regarding the second content, it should be noted that the embodiments of the present disclosure do not specifically limit the target content, and the second content may include a text or an image.

In one example, when the first content includes the content associated with the first resource, the second content may include the content associated with the first resource. In this way, through the first interface, the user can obtain more information associated with the first resource. In one example, considering that an image conveys more intuitive information as compared with text, the second content may include an image associated with the first resource.

In another example, when the first resource is a goods and the first content includes a content associated with a provider of the first resource, the second content may include a content associated with the first resource.

This is illustrated with examples.

For example, when the first resource is a goods, the first content may be a content associated with the goods, and the second content may be an image associated with the goods, the content associated with the goods may include one or more of a name of the goods, introduction of the goods, an attribute of the goods, etc.; and the image associated with the goods may be an image including the goods (which may also be referred to as a “goods image” for short).

For another example, when the first resource is a goods, the first content may be a content associated with a store that provides the goods, and the second content may be an image associated with the goods.

For another example, when the first resource is a store, the first content may be a content associated with the store, and the second content may be an image of a goods provided by the store.

For another example, when the first resource is a store, the first content may be a content associated with a goods provided by the store, and the second content may be an image of the goods provided by the store. In one example, when the second content includes an image associated with the first resource, in order to improve interactive experience of the user, the user may also perform a trigger operation on the image associated with the first resource, to complete the corresponding interactive behavior.

In one example, the user may trigger a first trigger operation on the image associated with the first resource, and accordingly, the client may display a resource transfer interface corresponding to the first resource in response to the first trigger operation. In one example, the resource transfer interface displays resource transfer information, and the resource transfer information is used for indicating a second resource required to acquire the first resource. The first resource and the second resource may be resources of different types. For example, the first resource is a goods and the second resource is a coupon.

After the resource transfer interface is displayed, the user may trigger a resource transfer completion operation on the resource transfer interface; and the resource transfer completion operation is used for confirming obtaining the first resource by using the second resource. Correspondingly, the client may acquire the first resource in response to the resource transfer completion operation.

The first trigger operation is not specifically limited in the embodiments of the present disclosure, and the first trigger operation may be, for example, a double-click operation, or may also be, for example, a long press operation, which are not listed one by one here.

In another example, the user may perform a second trigger operation on the image associated with the first resource, and accordingly, the client may display at least one interactive control in response to the second trigger operation. The user may trigger a corresponding interactive operation through the at least one interactive control. Taking a target control in the at least one control as an example, the user may perform a trigger operation on the target control; and correspondingly, the client may execute an interactive function corresponding to the interactive control in response to the trigger operation on the target interactive control.

The embodiments of the present disclosure do not specifically limit the target interactive control. In one example, the target interactive control may be an add-to-favorites control, and the user may perform a trigger operation on the add-to-favorites control, and correspondingly, the client may add the first resource to favorites in response to the trigger operation on the add-to-favorites control. In one example, the client may add the first resource to a favorite resource list, and the user may view the first resource through the watch resource list.

Next, the information display method provided by the embodiment of the present disclosure is introduced in conjunction with the accompanying drawings.

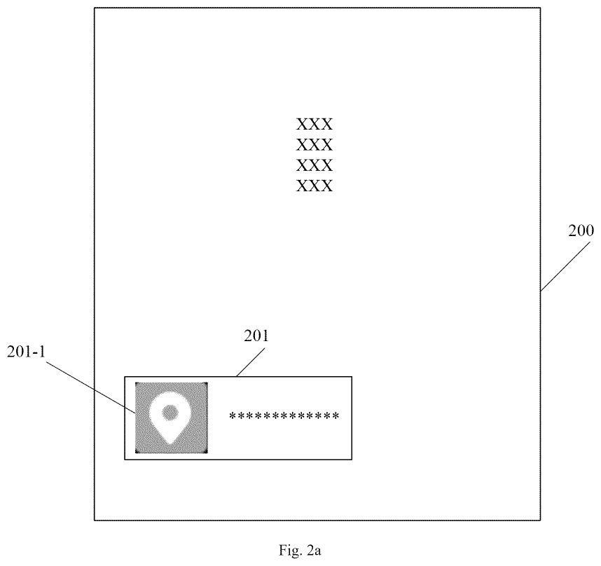

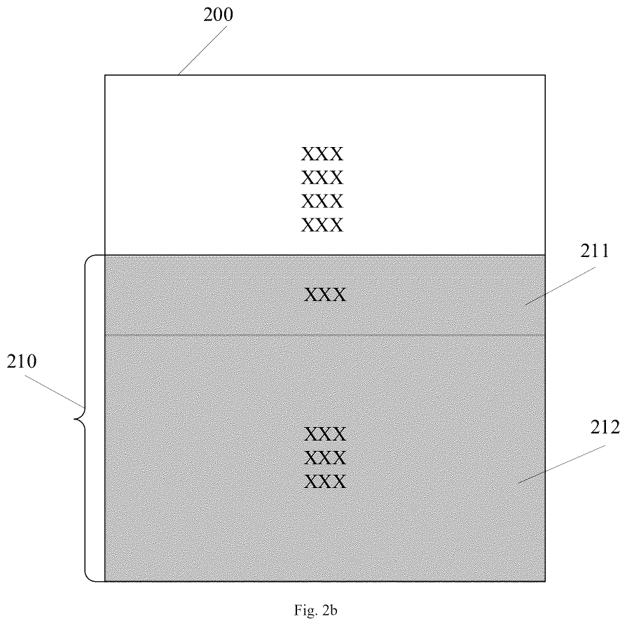

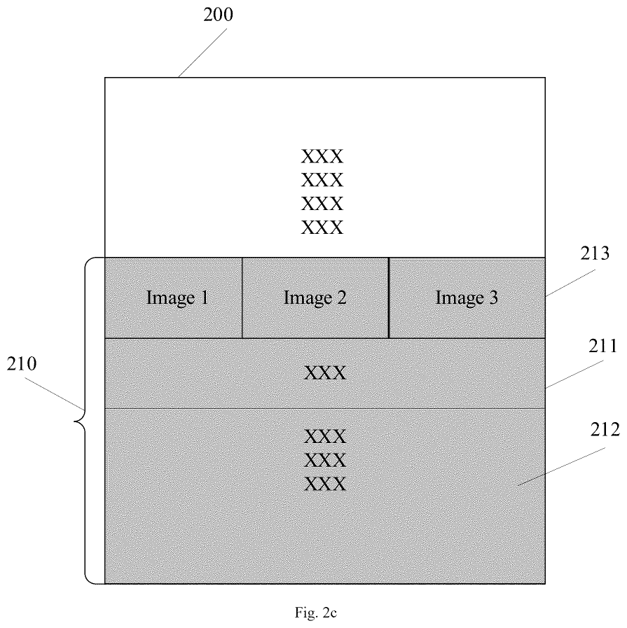

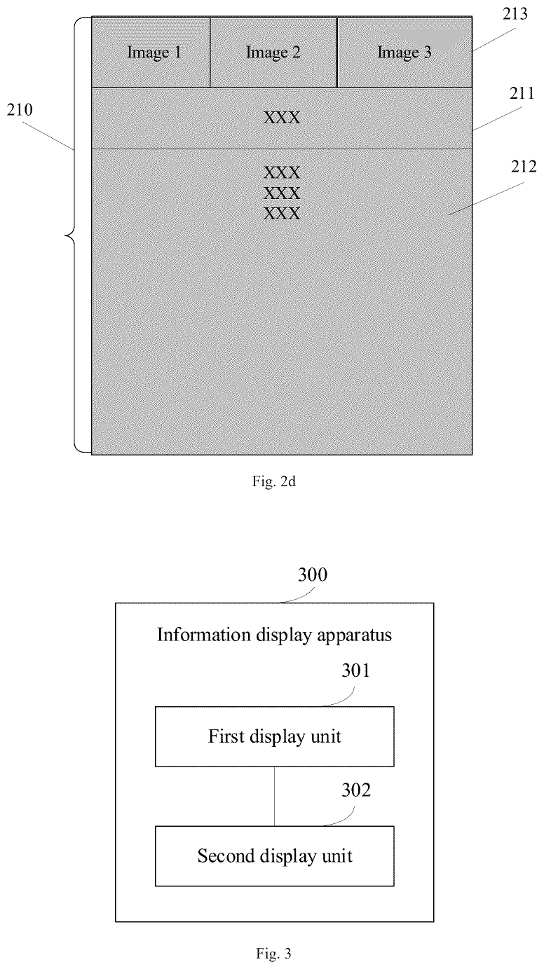

Referring to FIG. 2a, FIG. 2a is a schematic diagram of a video playback page provided by an embodiment of the present disclosure.

As shown in FIG. 2a, the video playback page 200 includes an interactive identifier 201, and other content on the video playback page 200 is represented by “XXX” in FIG. 2a. In FIG. 2a, the interactive identifier includes an interactive icon 201-1 and a name “***” of the first resource.

After the user performs a trigger operation through the interactive identifier 201, the client displays a first interface 210 in a form of window on the video playback page 200. As shown in FIG. 2b, FIG. 2b is a schematic diagram of a video playback page provided by an embodiment of the present disclosure. A top region of the first interface 210 displays information 211 (corresponding to first information) associated with the first resource and other information 212.

After the user performs a trigger operation on the first interface 210, it may be understood by referring to FIG. 2c, and FIG. 2c is a schematic diagram of a video playback page provided by an embodiment of the present disclosure. The top region of the first interface displays a second content 213, and the information 211 associated with the first resource is displayed in an adjacent region of the top region. In addition, the first interface also displays other information 212. In FIG. 2c, a case that the target content 213 includes 3 images (image 1, image 2, and image 3) is taken as an example for description.

After the user slides to the top of the video playback page 200, as shown in FIG. 2d, the client displays the first interface in full screen.

It should be noted that FIG. 2a to FIG. 2d are shown for convenience of understanding the solution of the present disclosure and do not constitute limitations on the embodiments of the present disclosure.

### Exemplary Device

Based on the method provided by the above embodiments, an embodiment of the present disclosure further provides an apparatus, and the apparatus is introduced below in conjunction with the accompanying drawings.

Referring to FIG. 3, which is a structural schematic diagram of an information display apparatus provided by an embodiment of the present disclosure. The apparatus 300, for example, may specifically include: a first display unit 301 and a second display unit 302.

The first display unit 301 is configured to display a first interface on a video playback page in response to a trigger operation on an interactive identifier on the video playback page, and a top region of the first interface displays a first content.

The second display unit 302 is configured to display a second content in the top region of the first interface and display the first content in other region except the top region, in response to a slide operation triggered on the first interface.

Optionally, displaying the first content in the other region except the top region comprises: displaying the first content in an adjacent region of the top region.

Optionally, the apparatus further comprises:
a third display unit, configured to display the first interface in full screen in response to ending of the slide operation.

Optionally, the first content comprises a content associated with a first resource, and the second content comprises an image associated with the first resource.

Optionally, the first content comprises a content associated with a provider of the first resource, and the second content comprises an image associated with the first resource.

Optionally, the apparatus further comprises:
a fourth display unit. configured to display a resource transfer interface corresponding to the first resource in response to a first trigger operation on the image associated with the first resource; and
an acquisition unit, configured to acquire the first resource in response to a resource transfer completion operation performed on the resource transfer interface.

Optionally, the apparatus further comprises:
a fifth display unit, configured to display at least one interactive control in response to a second trigger operation on the image associated with the first resource;
an interaction unit, configured to execute an interactive function corresponding to the interactive control in response to a trigger operation on a target interactive control in the at least one interactive control.

Optionally, the video playback page is a video playback page associated with the first resource, the interactive identifier is an interactive identifier associated with the first resource, and the first interface is a detail page of the first resource.

Because the apparatus 300 is an apparatus corresponding to the live streaming data processing method provided by the above method embodiments, specific implementations of respective units of the apparatus 300 all belong to the same concept as the above method embodiment. Therefore, the relevant description section of the above method embodiment may be referred to for the specific implementations of the respective units of the apparatus 300, and no details will be repeated here.

An embodiment of the present disclosure further provides a device, and the device includes a processor and a memory.

The processor is configured to execute instructions stored in the memory, so that the device can execute the information display method according to any one of the above method embodiments.

An embodiment of the present disclosure provides a computer readable storage medium, including instructions; and the instructions instruct a device to execute the information display method according to any one of the above method embodiments.

An embodiment of the present disclosure provides a computer program product, and the computer program product, when running on a computer, causes the computer to execute the information display method according to any one of the above method embodiments.

Those skilled in the art will easily think of other implementation solutions of the present disclosure after considering the specification and practicing the invention disclosed herein. The present disclosure is intended to cover any modifications, usages, or adaptive changes of the present disclosure; these modifications, usages, or adaptive changes follow the general principles of the present disclosure and include the common knowledge or commonly used technical means in the technical field not disclosed in the present disclosure. The specification and the embodiments are only to be regarded as exemplary, and a true scope and spirit of the present disclosure are indicated by the following claims.

It should be understood that the present disclosure is not limited to the precise structures that have been described above and shown in the accompanying drawings, and various modifications and changes may be made without departing from the scope thereof. The scope of the present disclosure is limited only by the appended claims.

The above descriptions merely are preferred embodiments of the present disclosure, and are not intended to limit the present disclosure. Any modification, equivalent substitution, improvement, and the like, made within the spirit and principles of the present disclosure should be covered within the protection scope of the present disclosure.

1. An information display method, comprising:
displaying a first interface on a video playback page in response to a trigger operation on an interactive identifier on the video playback page, wherein a first region of the first interface displays a first content; and
displaying a second content in the first region of the first interface and displaying the first content in a second region, in response to a slide operation triggered on the first interface.

2. The method according to claim 1, wherein the displaying the first content in a second region comprises:
displaying the first content in an adjacent region of the first region.

3. The method according to claim 1, further comprising:
displaying the first interface in full screen in response to ending of the slide operation.

4. The method according to claim 1, wherein the first content comprises a content associated with a first resource, and the second content comprises an image associated with the first resource.

5. The method according to claim 1, wherein the first content comprises a content associated with a provider of the first resource, and the second content comprises an image associated with the first resource.

6. The method according to claim 4, further comprising:
displaying a resource transfer interface corresponding to the first resource in response to a first trigger operation on the image associated with the first resource; and
acquiring the first resource in response to a resource transfer completion operation on the resource transfer interface.

7. The method according to claim 4, further comprising:
displaying at least one interactive control in response to a second trigger operation on the image associated with the first resource; and
executing an interactive function corresponding to a target interactive control in response to a trigger operation on the target interactive control in the at least one interactive control.

8. The method according to claim 1, wherein the video playback page is a video playback page associated with the first resource, the interactive identifier is an interactive identifier associated with the first resource, and the first interface is a detail page of the first resource.

9. (canceled)

10. A device, wherein the device comprises a processor and a memory;
the memory is configured to store instructions,
the processor is configured to execute the instructions stored in the memory, to cause the device to execute an information display method, which comprises:
displaying a first interface on a video playback page in response to a trigger operation on an interactive identifier on the video playback page, wherein a first region of the first interface displays a first content; and
displaying a second content in the first region of the first interface and displaying the first content in a second region, in response to a slide operation triggered on the first interface.

11. A non-transitory computer readable storage medium, comprising instructions,
wherein the instructions, when executed by a processor, instruct a device to execute an information display method, which comprises:
displaying a first interface on a video playback page in response to a trigger operation on an interactive identifier on the video playback page, wherein a first region of the first interface displays a first content; and
displaying a second content in the first region of the first interface and displaying the first content in a second region, in response to a slide operation triggered on the first interface.

12. (canceled)

13. The device according to claim 10, wherein when performing a step of the displaying the first content in a second region, the device is caused to:
display the first content in an adjacent region of the first region.

14. The device according to claim 10, wherein the method further comprises:
displaying the first interface in full screen in response to ending of the slide operation.

15. The device according to claim 10, wherein the first content comprises a content associated with a first resource, and the second content comprises an image associated with the first resource.

16. The device according to claim 10, wherein the first content comprises a content associated with a provider of the first resource, and the second content comprises an image associated with the first resource.

17. The device according to claim 15, wherein the method further comprises:
displaying a resource transfer interface corresponding to the first resource in response to a first trigger operation on the image associated with the first resource; and
acquiring the first resource in response to a resource transfer completion operation on the resource transfer interface.

18. The device according to claim 15, wherein the method further comprises:
displaying at least one interactive control in response to a second trigger operation on the image associated with the first resource; and
executing an interactive function corresponding to a target interactive control in response to a trigger operation on the target interactive control in the at least one interactive control.

19. The device according to claim 10, wherein the video playback page is a video playback page associated with the first resource, the interactive identifier is an interactive identifier associated with the first resource, and the first interface is a detail page of the first resource.

20. The non-transitory computer readable storage medium according to claim 11, wherein when performing a step of the displaying the first content in a second region, the instructions further instruct the device to:
display the first content in an adjacent region of the first region.

21. The non-transitory computer readable storage medium according to claim 11, wherein the method further comprises:
displaying the first interface in full screen in response to ending of the slide operation.

22. The non-transitory computer readable storage medium according to claim 11, wherein the first content comprises a content associated with a first resource, and the second content comprises an image associated with the first resource; or wherein the first content comprises a content associated with a provider of the first resource, and the second content comprises an image associated with the first resource.
